(19) United States
(12) Patent Application Publication
(10) Pub. No.: US 2010/0060571 A1
(43) Pub. Date: Mar. 11, 2010

(54) KVM SWITCH USING A TOUCH SCREEN

(75) Inventors: Yong Ling Chen, Richmond (CA); Zhi Ning Gao, Richmond (CA)

Correspondence Address: YING CHEN;Chen Yoshimura LLP, 255 S. GRAND AVE., # 215, LOS ANGELES, CA, 90012, US

(73) Assignee: ATEN INTERNATIONAL CO., LTD., Taipei (TW)

(21) Appl. No.: 12/208,308

(22) Filed: Sep. 10, 2008

(51) Int. Cl. G06F 3/038

(52) U.S. Cl. 345/157

(57) ABSTRACT

A KVM switch system having a touch screen for interacting with multiple computers is disclosed. The KVM switch processes coordinate data from the touch screen and transfers the processed data to the controlled computer either as absolute mouse coordinate data or as relative mouse coordinate data depending on the operating system (Windows, Mac OS, SUN, etc.) and mouse data interface (USB, PS/2, etc.) used by the computer. Thus, the touch screen can interact with all computers connected to the KVM switch, achieving a multi-platform and multi-interface application without requiring device drivers on the computers. The KVM switch stores necessary parameters for each computer so that when switching from one computer port to another, or when the display resolution of the computer changes, processing of the touch screen data is automatically adjusted accordingly. The touch screen also works within the OSD of the KVM switch.

### BACKGROUND OF THE INVENTION

1. Field of the Invention

This invention relates to KVM (keyboard-video-mouse) switches, and in particular, it relates to KVM switches using a touch screen user interface to interact with multiple connected computers.

2. Description of the Related Art

Touch screens are widely used for users to interact with electronic devices. Examples include bank ATMs (automatic teller machines), ticket machines for public transportation systems, tablet computers, etc. Conventional touch screens are designed for particular electronic devices and typically can only be used with the corresponding electronic device. For example, a touch screen for an ATM will only work with that model of ATM. Due to hardware differences in the different electronic devices, a conventional touch screen cannot interact with multiple different electronic devices.

Touch screens have been employed in KVM (keyboard-video-mouse) switch systems. One example is a “KVM drawer with touch screen LCD” made by Black Box (refer to http://www.blackbox.com/Catalog/Detail.aspx?cid=537,1393,1395&mid=5272). In this system, the touch screen is connected to a single computer with a special USB cable, and can only control the connected computer. A device driver is required on the computer to work with the touch screen. Another example is described in U.S. Patent Application Publication No. 2002/0054029, which describes a “method for providing information via an interactive display system includes activating the system when inputting a command by touching an interactive display screen. The command is transmitted to a remote client computer via a KVM extender.” Again, the touch screen only works with the single remote computer connected to the touch screen.

### SUMMARY OF THE INVENTION

Accordingly, the present invention is directed to a KVM switch system having a touch screen that substantially obviates one or more of the problems due to limitations and disadvantages of the related art.

An object of the present invention is to provide a KVM switch system using to interact with all computers connected to the KVM switch.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a KVM (keyboard-video-mouse) switch which includes: a plurality of computer ports each for connecting to one of a plurality of computers; at least one console port for connecting to a user console which includes a touch screen; a switching section for selectively connecting one of the plurality of computer ports to the console port; and a control section connected to the switching section for controlling the switching section, wherein the control section determines a type of operating system of the computer connected to the selected computer port, receives touch screen coordinate data from the touch screen via the console port, processes the touch screen coordinate data and converts them to absolute mouse coordinate data or relative mouse coordinate data or both, and outputs either the absolute mouse coordinate data or the relative mouse coordinate data to the selected computer port depending on the type of operating system of the computer connected to that computer port.

In another aspect, the present invention provides a method implemented in a KVM switch of a KVM switch system having a touch screen, which includes: (a) selectively connecting one of the plurality of computer ports to the console port; (b) determining a type of operating system of the computer connected to the selected computer port; (c) receiving touch screen coordinate data from the touch screen via the console port; (d) processing the touch screen coordinate data and converting them to absolute mouse coordinate data or relative mouse coordinate data or both; and (e) outputting either the absolute mouse coordinate data or the relative mouse coordinate data to the selected computer port depending on the type of operating system of the computer connected to that computer port.

In another aspect, the present invention provides a computer program product that causes a data processing apparatus including a touch screen to perform the above process.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a KVM switch system according to embodiments of the present invention.

FIG. 2 schematically illustrates edge calibration for the touch screen.

FIG. 3 schematically illustrates two-point calibration for the touch screen.

FIG. 4 is a flow diagram illustrating an enumeration process.

FIGS. 5A and 5B are flow diagrams illustrating a process for processing touch screen data performed by the KVM switch.

FIGS. 6A and 6B show a KVM switch with a touch screen.

### DETAILED DESCRIPTION OF THE PREFERRED EMBODIMENTS

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. The following presents a detailed description of the preferred embodiment (as well as some alternative embodiments) of the present invention.

Embodiments of the present invention employ touch screens in KVM (keyboard-video-mouse) switches to accomplish convenient, fast control. The touch screen of the KVM switch can control all integrated ports of the KVM switch (up to 512 in one example). It is multi-platform (compatible with PC, Mac, SUN, etc.) and multi-interface (can use USB and PS/2 interface for mouse data). In addition, no device driver is needed on the controlled computer.

Embodiments of the present invention employ a unique calibration method that combines edge calibration, two-point calibration, and single-point calibration to calibrate the touch screen for devices with different platforms and different interfaces without requiring device drivers to be installed on the controlled devices. The calibration parameters are stored in the KVM switch so that no re-calibration is necessary when switching ports. Further, re-calibration is automatically carried out when the display resolution of a controlled computer changes.

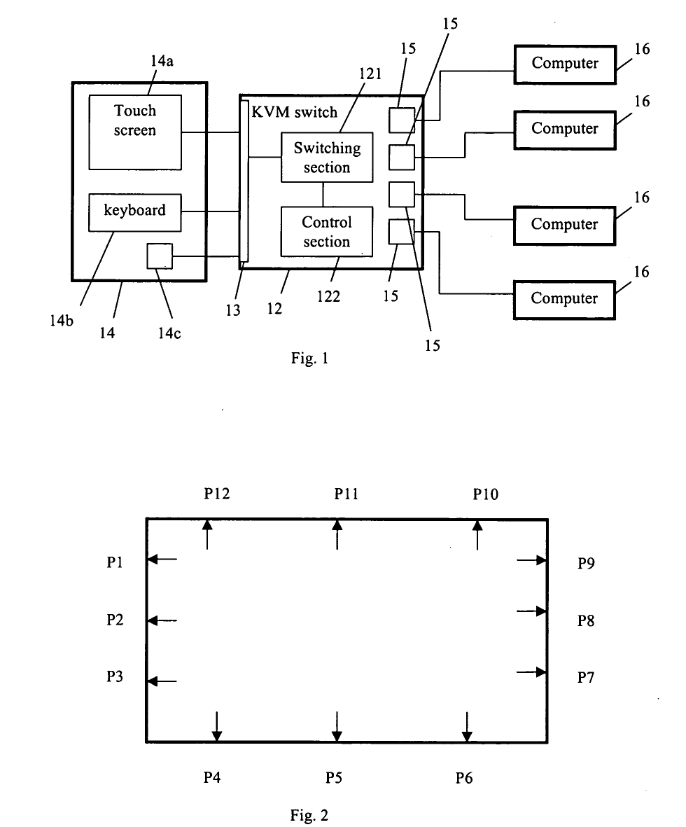

FIG. 1 schematically illustrates a KVM switch system according to embodiments of the present invention. The system includes a KVM switch 12 having a plurality of computer ports 15 and at least one console port 13, a plurality of computers 16 each connected to a computer port 15 of the KVM switch 12, and one or more user consoles 14 each connected to a console port 13 of the KVM switch 12 (one user console 14 is shown here). The KVM switch 12 includes a switching section 121 that selectively connects one of the computer ports to a console port to allow the user to interact with the selected computer 16 using the user console 14. It also includes a control section 122, which may be implemented as a microcontroller unit or other suitable circuitry, for controlling the functions of the KVM switch 12 including processing of the data from the touch screen 14a described in more detail later. The control section 122 also includes a memory (not shown in FIG. 1) for storing various data. The switching section 121, as well as other components not shown in FIG. 1 may have structures found in conventional KVM switches and are not described in further detail here.

The user console 14 includes a touch screen 14a such as an LCD touch screen. The touch screen 14a includes structures that can detect the physical location of a user's finger, a stylus or other pointing objects. Touch screens are generally known in the art and its hardware structures are not described in detail here. The user console may optionally include a keyboard or other character input devices 14b and an external pointing device 14c such as a mouse, a touch pad, a trackball, etc. In this disclosure, the term “mouse” is used to broadly refer to a pointing device other than the touch screen 14a.

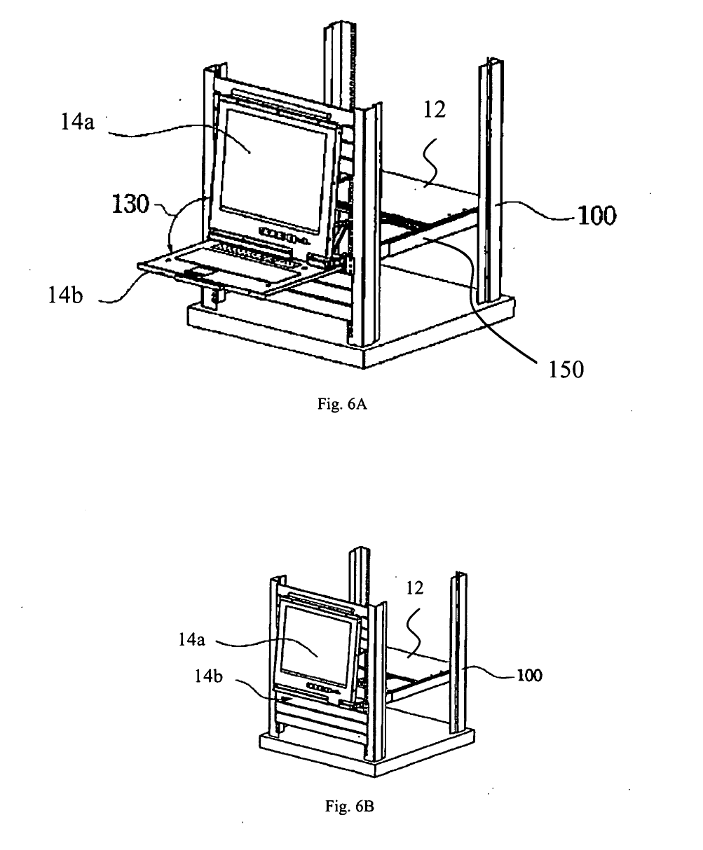

Referring to FIG. 6A and FIG. 6B, the user console 14 or parts thereof may be physically integrated with the KVM switch 12. The KVM switch 12 and the console 14 may be installed on a server rack 100. Further, the KVM switch 12 may be in a stationary configuration and the console 14 may be movable along at least of a pair of sliding rails 150 with respect to the server rack 100. Alternatively, the touch screen 14a and the keyboard 14b may have respective sliding rails so that the touch screen 14a and the keyboard 14b are independently movable. For example, as shown in FIG. 7B, when the touch screen 14a is pull out of the server rack 100, the keyboard 14b can be still stowed in the server rack 100. For example, as the curve 130 indicates, the touch screen 14a may form a unit pivotally connected to another unit that contains the KVM switch 12. In addition, the keyboard 14b and mouse 14c may be a laptop-style keyboard and mouse combination that is formed in the same unit as the KVM switch. Alternatively, the touch screen, keyboard, and/or mouse may be separate units connected to the KVM switch 12 by cables. As another alternative, the touch screen 14a may be integrated with the KVM switch, and the keyboard 14b, mouse 14c and an additional display monitor (non-touch screen) are externally connected to the KVM switch 12 by cables. The connections between the touch screen 14a, keyboard 14b and mouse 14c and the KVM switch may use a USB or PS/2 interface or other desirable interfaces.

As mentioned above, the touch screen device is implemented such that the device is compatible with multiple operating systems (i.e. multi-platform). In terms of their handling of touch screen devices, current popular computer systems fall into two categories. The first category, including computers running the Mac OS X, more recent versions of Windows (Windows 2000 and up) and certain other operating systems using a USB interface for transferring mouse data to the computer, support absolute mouse coordinate data through standard USB protocols. For this category of systems, the touch screen 14a is added to the device list of the KVM switch 12, its HID (human interface device) descriptors are modified as appropriate, and the device is reported to the operating system of the computer 16. The calibrated touch screen coordinate data (after edge calibration) is passed to the operating system of the computer 16, and the operating system obtains the exact locations of the touched points. The second category of systems, including computers running Windows and other operating systems using a PS/2 interface for transferring mouse data to the computer, and computers running older versions of Windows (WIN98 or lower), SUN, Linux and certain other systems using USB interface for transferring mouse data to the computer, do not support absolute touch screen data. For this category of systems, the KVM switch 12 converts the absolute coordinate values of touched points to normal relative mouse coordinate values which are transferred to the computer 16. In other words, the KVM switch 12 processes and transfers touch screen data to the computer as absolute mouse coordinates or as relative mouse coordinates depending on the operating system and/or the interface type of the computer system.

Relative mouse coordinate is the cumulative mouse movement amount between the current mouse cursor position and the last mouse cursor position. Relative mouse coordinate (a vector) is calculated from absolute mouse coordinates for the last and current cursor positions using the following equations:

X_{Relative}=(X_{Curr}−X_{Last})/X_{coefficient}

Y_{Relative}=(Y_{curr}−Y_{Last})/Y_{coefficient} (1)

where X_{Relative} and Y_{Relative} are the relative mouse coordinate values, X_{Curr} and Y_{Curr} are the absolute coordinate values of the current mouse cursor position, X_{Last} and Y_{Last} are the absolute coordinate values of the last mouse cursor position, and X_{coefficient} and X_{coefficient} are a pair of conversion coefficients referred to as transfer rate. The transfer rate is dependent on the display resolution set on the computer 16.

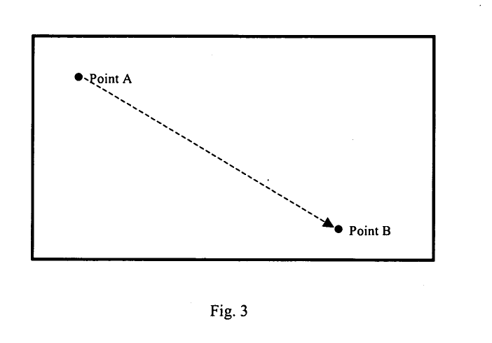

Several calibration procedures may be employed to calibrate the touch screen 14a. First, the minimum and maximum X, Y values of the touch screen 14a are obtained via an edge calibration procedure. This calibration is desired because the maximum and minimum values (which represent the edges of the touch screen) are not exactly the same for all touch screens due to decentralization. Edge calibration is done by touching a few points on each edge of the touch screen, obtaining the absolute X and Y coordinates of these points and calculating the average edge values. In a preferred embodiment, a 12-point edge calibration procedure is employed, as schematically illustrated in FIG. 2. The user touches twelve points P1 to P12 distributed on the four edges of the touch screen as shown in FIG. 2. The absolute X and Y positions of the touched point are obtained, and the average minimum and maximum X and Y coordinate values, denoted Xₘᵢₙ, Xₘₐₓ, Yₘᵢₙ and Yₘₐₓ, are calculated as follows:

Xₘᵢₙ=(X_{P1}+X_{P2}+X_{P3})/3

Xₘₐₓ=(X_{P7}+X_{P8}+X_{P9})/3

Yₘᵢₙ=(Y_{P10}+Y_{P11}+Y_{P12})/3

Yₘₐₓ=(Y_{P4}+Y₅+Y₆)/3 (2)

where the various X and Y values X_{P1}, Y_{P1}, etc. are absolute coordinates of the locations. The calculated parameters are stored in the memory of the control section 122 of the KVM switch 12, and are used in further calibrations and calculation.

Edge calibration is performed once for each touch screen. If the touch screen is physically integrated with the KVM switch, edge calibration may be performed at the factory before the touch screens are shipped to customers. If the touch screen is plugged into the KVM switch by a cable, edge calibration may be performed at the factory and the calibration data may be stored in a memory of the touch screen, which may be later transferred to the KVM switch 12 when the touch screen is plugged into the KVM switch. Alternatively, edge calibration may be performed by the user after the touch screen is plugged into the KVM switch.

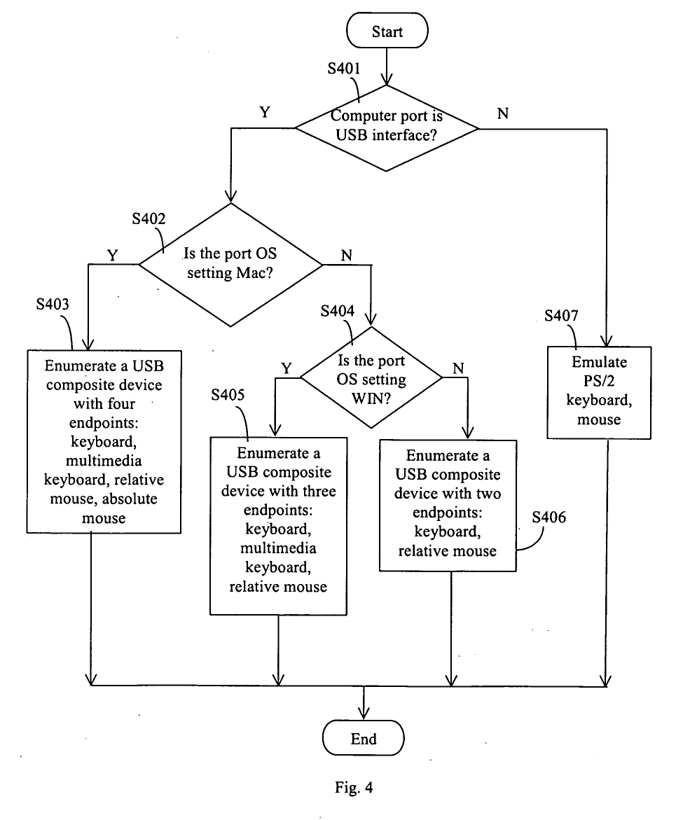

The transfer rate of the touch screen 14a is obtained via a two-point calibration procedure. Two-point calibration procedure is carried out for the second category of systems described above. It is carried out by a user by running a calibration program on the KVM switch 12, which displays instructions to instruct the user to perform the relevant steps. Before two-point calibration, the selected computer 16 connected to the computer port of the KVM switch 12 is booted up and it is made sure that the external mouse 14c of the user console 14 is working properly for the selected computer 16. Using the external mouse 14c, the mouse cursor is moved to a first point on the touch screen, shown as Point A in FIG. 3. The user touches the mouse cursor at Point A, and the KVM switch 12 obtains the absolute coordinate values of Point A, denoted X_{A}, Y_{A}. Then, the mouse cursor is moved to a second point, shown as Point B in FIG. 3. The user touches the mouse cursor at Point B, and the KVM switch 12 obtains the absolute coordinate values of Point B, denoted X_{B}, Y_{B}. While the mouse moves from Point A to Point B, the KVM switch 12 also obtains the cumulative mouse movement increment values ΣXₘₒᵥₑ and ΣYₘₒᵥₑ, which are algebraic sums of relative mouse coordinate values when the mouse cursor moves from Point A to Point B. The transfer rate X_{coefficient} and Y_{coefficient} are calculated as follows:

X_{coefficient}=((X_{B}−X_{A})/ΣXₘₒᵥₑ)

Y_{coefficient}=((Y_{B}−Y_{A})/ΣYₘₒᵥₑ). (3)

Two-point calibration is performed once for each computer 16 plugged into a computer port of the KVM switch 12, and does not need to be re-performed when the computer 16 is turned off and on again. Two-point calibration is re-performed if a new computer is plugged into a computer port.

Further, while the transfer rate is dependent on the display resolution set on the computer 16, two-point calibration is performed only once at a particular display resolution to obtain the transfer rate for that resolution (referred to as calibrated transfer rate for convenience). The transfer rate for other display resolutions are calculated using the following equations:

X_{coefficient K2}=X_{coefficient K1}*Resolution[K1][0]/Resolution[K2][0]

Y_{coefficient K2}=Y_{coefficient K1}*Resolution[K1][1]/Resolution[K2][1] (4)

where Resolution is an Nx2 two-dimensional array representing various display resolutions supported by the computer 16, K1 is the display resolution at which the two-point calibration is carried out (i.e. X_{coefficient K1} and Y_{coefficient K1} are the calibrated transfer rate), and K2 is the current display resolution. The array Resolution is stored in the memory of the control section 122 of the KVM switch 12. In one particular example, the array Resolution is:
Resolution[8][2]={{640, 400}, {640, 480}, {800, 600}, {1024, 768}, {1152, 864}, {1280, 960}, {1280, 1024}, {1600, 1200}}.

Thus, two-point calibration does not need to be re-performed when the display resolution setting of the selected computer 16 changes. In a preferred embodiment, the KVM switch 12 detects changes in the display resolution setting of the computer 16, and automatically calculates and applies the appropriate transfer rate for the new display resolution

A single-point calibration procedure may also be carried out for the second category of systems described above. This procedure is desired because the cumulative errors may result in discrepancies between the coordinate values in the touched point and the mouse cursor. Thus, a single-point calibration is carried out to match the touch point and the mouse cursor, i.e., to find the exactly mouse cursor location. To perform single-point calibration, the user runs a calibration program on the KVM switch 12, moves the mouse cursor to a location on the screen, and touches the mouse cursor for a brief moment. The calibration program obtains the absolute X and Y coordinates of the touched point, and calculates a discrepancy between the touch screen absolute coordinates and the coordinates of the mouse cursor. The discrepancy values are stored in the KVM switch 12 and used for correcting the touch screen absolute X and Y coordinates for second category of computer systems.

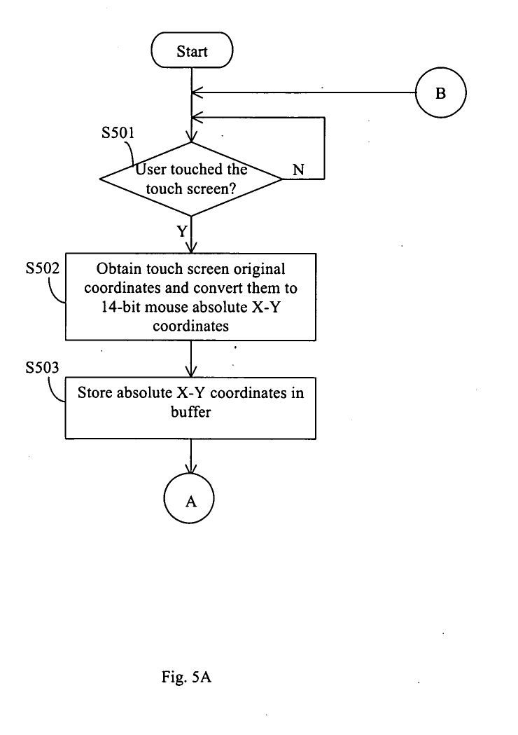

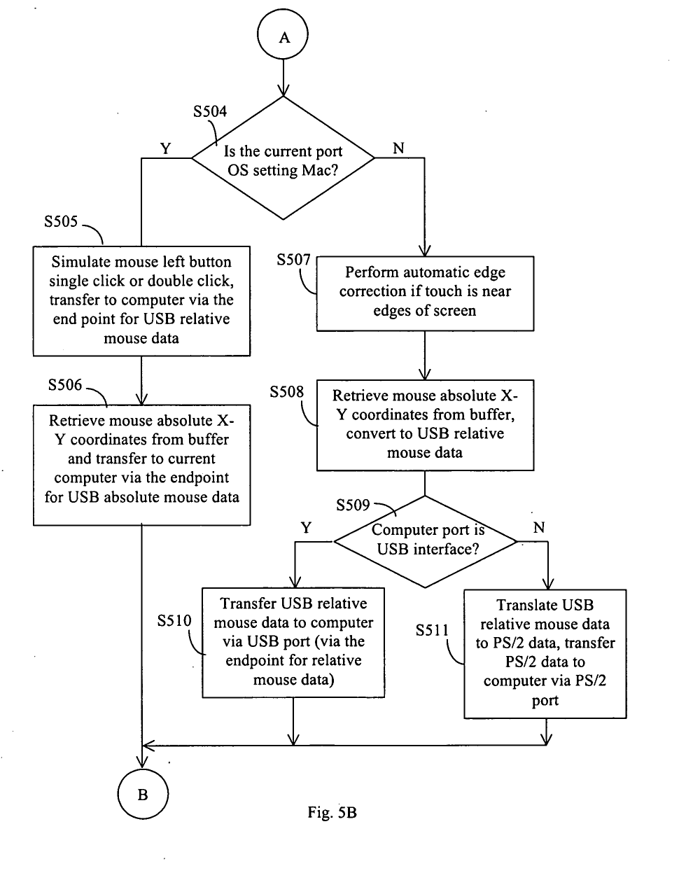

The touch screen control method performed by the KVM switch 12 according to one embodiment of the present invention is now described with reference to FIGS. 4, 5A and 5B. This process is performed by the control section 122 of the KVM switch 12. FIG. 4 illustrates an enumeration process. This process is performed for each computer port when a computer 16 is plugged (including unplugged and re-plugged) into the computer port, or when the computer 16 is turned on. First, the KVM switch 12 detects whether the computer port for transferring mouse data is a USB interface (step S401). This detection is automatic, based on the cable connection. If the interface is USB (“Y” in step S401), the KVM switch further determines whether the operating system setting of the selected computer port is the Mac OS (step S402). The operating system setting of each computer port has been previously set (manually) and stored in a memory of the KVM switch 12. Thus, step S402 is accomplished by checking the memory to determine the operating system setting of the selected computer port.

If the operating system setting is Mac (“Y” in step S402), the KVM switch 12 enumerates to the computer 16 a USB composite device with four endpoints: EP1: keyboard; EP2: multimedia keyboard; EP3: relative mouse; EP4: absolute mouse (step S403). EP4 is for transferring the touch screen data. If the operating system setting is not Mac (“N” in step S402), the KVM switch 12 determines whether the operating system setting of the selected computer port is Windows (step S404). If it is (“Y” in step S404), the KVM switch 12 enumerates to the computer 16 a USB composite device with three endpoints: EP1: keyboard; EP2: multimedia keyboard; EP3: relative mouse (step S405). If it is not (“N” in step S404), then the operating system is SUN or other operating systems, and the KVM switch 12 enumerate to the computer 16 a USB composite device with two endpoints: EP1: keyboard; EP2: relative mouse (step S406). Of course, in steps S403, S405 and S406, the KVM switch 12 can enumerate other USB computer devices as long as they contain the relative and absolute mouse (for Mac OS) or the relative mouse (for other systems).

If the computer port is not a USB interface (“N” in step S401), the KVM switch 12 emulates a PS/2 keyboard and mouse for the computer 16 (step S407).

The steps S401 to S407 do not need to be performed when a computer port is switched away from the user console 14 and then re-switched to the user console, so long as the computer connected to the computer port is continued to be turned on.

It is noted that although computers running recent versions of Windows with USB interface can support absolute touch screen data through standard USB protocols (i.e. they fall into the first category of systems), in the particular embodiment described here, all Windows system regardless of the interface (USB or PS/2) are treated as the second category of systems, i.e., relative mouse data are transferred to the computer. This is convenient because the KVM switch 12 need not determine which version of Windows is running. Because current versions of Mac OS use mouse acceleration, relative coordinates cannot be used to implement touch screens in such systems. More recent versions of Windows also use mouse acceleration, but they allow acceleration to be turned off so relative coordinates can be used to implement touch screens. When both absolute and relative coordinate data can be used for a particular computer system, which method to use is a design choice. The invention is not limited to such particular design choices. More generally, the KVM switch 12 determines the kind of system the computer 16 and performs corresponding steps appropriate for the computer system.

FIGS. 5A and 5B illustrate a process of touch screen data processing. The KVM switch 12 detects whether the touch screen is touched by the user (step S501). If it is touched (“Y” in step S501), the KVM switch 12 obtains the touch screen original coordinates (and applies appropriate correction) and converts them to mouse absolute X-Y coordinates (step S502). The conversion uses the minimum and maximum X and Y coordinate values Xₘᵢₙ, Xₘₐₓ, Yₘᵢₙ and Yₘₐₓ previously obtained by edge calibration and stored in the KVM switch 12. In a preferred embodiment, the absolute X-Y coordinates are represented by a 14-bit number. The absolute X-Y coordinates are stored in a buffer in the KVM switch 12 (step S503).

Next, as shown in FIG. 5B, the KVM switch 12 again determines whether the operating system of the computer 16 is the Mac OS (step S504). If it is (“Y” in step S504), the KVM switch 12 simulates a mouse left button single click or double click based on the touching speed and the size of the touched area of the user's touch(es), and transfers that data to the computer 16 via the USB endpoint for relative mouse (EP3) (step S505). That is, via the KVM switch 12, the selected computer 16 deems that the data from the touch screen 14a is the relative mouse data, rather than the absolute mouse data. Methods for simulating mouse clicks based on touch screen touches are known in relevant art and any such methods may be employed. The KVM switch 12 also retrieves the mouse absolute X-Y coordinates from the buffer and transfers them to the computer 16 via the USB endpoint for absolute mouse (EP4) (step S506).

If the operating system of the computer 16 is not Mac OS (“N” in step S504), the KVM switch 12 performs automatic edge correction if the user touches near the edges of the screen (step S507). Such correction is desirable because touch screens often have distortions or errors (e.g. they may not be perfectly rectangular) and correction is desirable when the touch is near the edge. This connection is done by sending large relative mouse coordinate values to the computer to make sure the mouse cursor is out of the screen if the user touches near the edge of touch screen.

Then (if the touch is not near the edge of the touch screen), the KVM switch 12 retrieves the mouse absolute X-Y coordinates from the buffer, and converts them to mouse relative coordinates (step S508). Then, the KVM switch 12 determines whether the current computer port is a USB interface (step S509). If it is (“Y” in step S509), the KVM switch 12 transfers the USB relative mouse coordinate data to the computer 16 via the USB endpoint for relative mouse (EP3) (step S510). The transfer may be done as one transfer or several transfers. If the interface is not USB (“N” in step S509), the KVM switch translates the USB relative mouse data to PS/2 data, and transfers the PS/2 data to the computer via the PS/2 port (step S511). The process then continues to wait for another touch screen touch.

The conversion in step S508 is done using equations (1) described above. When applying equation (1), X_{Curr} and Y_{Curr} are the retrieved absolute coordinate values of the touched position, and X_{Last} and Y_{Last} are the absolute coordinate of the last mouse cursor position, regardless of whether the last mouse cursor position was generated by the touch screen 14a or by the external mouse 14c (if present).

The last mouse cursor position coordinates X_{Last} and Y_{Last} are continuously updated whenever the touch screen 14a is touched and the external mouse 14c is moved. In other words, the KVM switch 12 tracks the movement of the external mouse, and calculates the relative coordinates correctly when the touch screen is touched after mouse movement. This is done for both USB and PS/2 interfaces.

For each computer 16 connected to a computer port of the KVM switch 12 and turned on, whether or not the computer is switched to the user console 14, the absolute coordinate of the last mouse cursor position is stored in the KVM switch 12. In addition, as mentioned earlier, the transfer rate and display resolution of each computer connected to a computer port are also stored in the KVM switch 12. When a computer port is switched to the user console, these parameters are retrieved from the memory and used to perform various calculations described above. As a result, when the KVM switch 12 switches from one computer port to another, no re-calibration is necessary and the switching is transparent.

Using the above-described approach, the touch screen 14a can be used to interact with any computer connected to a computer port of the KVM switch (provided that it uses one of the operating systems and interfaces supported by the KVM switch). No device driver needs to be installed on the computer. The computer receives either absolute mouse coordinates (if the computer supports absolute mouse coordinates), or relative mouse coordinates. These data are normal mouse data for the computer's operating system and can be handled without special device driver.

The touch screen 14a can be implemented to work with the OSD (on-screen display) system of the KVM switch 12. OSD is a graphical user interface through which the KVM switch 12 interacts with the user to accomplish various control functions, such as logging on to the KVM system, controlling various settings of the KVM switch, switching computer ports, etc. When the KVM switch 12 is in the OSD mode, it generates simulated horizontal and vertical sync signals for the touch screen to ensure that the location of the OSD menus stay constant. A two-point calibration is performed to obtain the location of the OSD menu on the screen, and the parameters are stored in the KVM switch 12. This calibration is performed once for each touch screen. When in the OSD mode, the KVM switch 12 determines whether a touch is within the OSD area, and converts the touch data to OSD mouse absolute coordinates. Right mouse single click and left mouse double click using the touch screen are also implemented within the OSD mode.

Although a KVM switch system is described above as an example an application of the present invention, the invention may be used to connect a touch screen to other electronic devices such as desktop computers, laptop computers, tablet computers, handheld computers, personal digital assistants (PDAs), etc. Software or firmware may be provided in such a touch screen device to detect what operating system and interface is present on the computer or other device that the touch screen is connected to, and to output either absolute mouse coordinates or relative mouse coordinates depending on the operating system and interface. Another embodiment of the invention is a software product that can be loaded onto a touch screen device to carry out the above process.

It will be apparent to those skilled in the art that various modification and variations can be made in the KVM switch system incorporating a touch screen and related methods of the present invention without departing from the spirit or scope of the invention. Thus, it is intended that the present invention cover modifications and variations that come within the scope of the appended claims and their equivalents.

What is claimed is:

1. A KVM (keyboard-video-mouse) switch comprising:
a plurality of computer ports each for connecting to one of a plurality of computers;
at least one console port for connecting to a user console which includes a touch screen;
a switching section for selectively connecting one of the plurality of computer ports to the console port; and
a control section connected to the switching section for controlling the switching section,
wherein when a type of operating system of the computer connected to the selected computer port is determined, the control section receives touch screen coordinate data from the touch screen via the console port, converts the touch screen coordinate data to absolute mouse coordinate data or relative mouse coordinate data or both, and outputs either the absolute mouse coordinate data or the relative mouse coordinate data to the selected computer port depending on the type of operating system of the computer connected to that computer port.

2. The KVM switch of claim 1, further comprising the user console including the touch screen connected to the console port.

3. The KVM switch of claim 1, wherein the control section detects a type of interface for transferring mouse data to the computer connected to the selected computer port, and outputs either the absolute mouse coordinate data or the relative mouse coordinate data to the selected computer port depending on the type of operating system and the type of interface.

4. The KVM switch of claim 1, wherein if the operating system of the computer connected to the selected computer port is Mac OS, the control section outputs the absolute mouse coordinate data to the selected computer port, and if the operating system is other than Mac OS, the control section outputs the relative mouse coordinate data to the selected computer port.

5. The KVM switch of claim 1, wherein
if the selected computer port uses a USB interface for transferring mouse data to the computer connected thereto and the operating system of the computer connected to the selected computer port is Mac OS, the control section enumerates to the computer a first USB (universal serial bus) composite device with multiple endpoints including an endpoint for a relative mouse and an endpoint for an absolute mouse, and transfers the absolute mouse coordinate data via the absolute mouse endpoint,
if the selected computer port uses the USB interface for transferring mouse data and the operating system is other than Mac OS, the control section enumerates to the computer a second USB composite device with multiple endpoints including an endpoint for a relative mouse, and transfers the relative mouse coordinate data via the relative mouse endpoint, and
if the selected computer port uses a PS/2 interface for transferring mouse data, the control section emulates a PS/2 keyboard and mouse for the computer, translates the relative mouse coordinate data to PS/2 mouse data, then transfers the PS/2 mouse data via the emulated PS/2 mouse.

6. The KVM switch of claim 1, wherein if the operating system of the computer connected to the selected computer port is Mac OS, the control section simulates a mouse left button single click or double click and transfers the simulated data to the selected computer port.

7. The KVM switch of claim 1, wherein the control section stores minimum and maximum X and Y coordinate values for the touch screen which have been obtained by a first calibration process, and wherein the control section converts the touch screen coordinate data to the absolute mouse coordinate data using the minimum and maximum X and Y coordinate values.

8. The KVM switch of claim 7, wherein the first calibration process includes:
touching a plurality of points on four edges of the touch screen;
obtaining the touch screen coordinate data for the plurality of points; and
calculating minimum and maximum X and Y coordinate values from the touch screen coordinate data for the plurality of points.

9. The KVM switch of claim 1, wherein for each of the plurality of computers connected to the computer ports, the control section stores a calibrated touch screen transfer rate, the calibrated touch screen transfer rate having been obtained by a second calibration procedure at a first display resolution of the respective computer.

10. The KVM switch of claim 9, wherein the user console includes an external mouse, and wherein the second calibration process includes:
moving a mouse cursor to a first point on the touch screen using the external mouse;
touching the first point;
moving the mouse cursor to a second point on the touch screen using the external mouse;
touching the second point;
obtaining the touch screen coordinate data for the touched first and second points;
obtaining cumulative mouse movement increment values when the mouse cursor moves from the first point to the second point; and
calculating the calibrated touch screen transfer rate using the touch screen coordinate data for the touched first and second points and the cumulative mouse movement increment values.

11. The KVM switch of claim 9, wherein the control section calculates a current touch screen transfer rate for a second display resolution currently set for the computer connected to the selected computer port using the calibrated touch screen transfer rate, and calculates the relative mouse coordinate data using the absolute mouse coordinate data and the current touch screen transfer rate.

12. The KVM switch of claim 11, wherein the control section re-calculates a current touch screen transfer rate when it detects a change in the display resolution of the computer connected to the selected computer port.

13. The KVM switch of claim 1, wherein the control section stores a last mouse cursor position for each of the plurality of computers connected to the computer ports, and calculates the relative mouse coordinate data using the last mouse cursor position for the computer connected to the selected computer port.

14. The KVM switch of claim 13, wherein the user console further includes an external mouse, and wherein the last mouse cursor position is generated by either the external mouse or the touch screen.

15. The KVM switch of claim 1, further comprising an OSD (on-screen display) section for generating OSD menus for display on the touch screen,
wherein when in a OSD mode, if a touch on the touch screen is within an OSD area, the control section converts the touch screen coordinate data to OSD mouse absolute coordinates.

16. In a KVM (keyboard-video-mouse) switch system including a KVM switch, a plurality of computers each connected to one of a plurality of computer ports of the KVM switch, and at least one user console including a touch screen connected to a console port of the KVM switch, a method performed by the KVM switch comprising:
(a) selectively connecting one of the plurality of computer ports to the console port;
(b) determining a type of operating system of the computer connected to the selected computer port;
(c) receiving touch screen coordinate data from the touch screen via the console port;
(d) converting the touch screen coordinate data to absolute mouse coordinate data or relative mouse coordinate data or both; and
(e) outputting either the absolute mouse coordinate data or the relative mouse coordinate data to the selected computer port depending on the type of operating system of the computer connected to that computer port.

17. The method of claim 16, further comprising:
(f) detecting a type of interface for transferring mouse data to the computer connected to the selected computer port;
wherein step (e) includes outputting either the absolute mouse coordinate data or the relative mouse coordinate data to the selected computer port depending on the type of operating system and the type of interface.

18. The method of claim 16, wherein step (e) comprises:
if the operating system of the computer connected to the selected computer port is Mac OS, outputting the absolute mouse coordinate data to the selected computer port, and if the operating system is other than Mac OS, outputting the relative mouse coordinate data to the selected computer port.

19. The method of claim 16, further comprising:
(g) if the selected computer port uses a USB interface for transferring mouse data to the computer connected thereto and the operating system of the computer connected to the selected computer port is Mac OS, enumerating to the computer a first USB (universal serial bus) composite device with multiple endpoints including an endpoint for a relative mouse and an endpoint for an absolute mouse, if the selected computer port uses the USB interface for transferring mouse data and the operating system is other than Mac OS, enumerating to the computer a second USB composite device with multiple endpoints including an endpoint for a relative mouse, and if the selected computer port uses a PS/2 interface for transferring mouse data, emulating a PS/2 keyboard and mouse for the computer,
wherein step (e) comprises: if the selected computer port uses a USB interface for transferring mouse data to the computer connected thereto and the operating system of the computer connected to the selected computer port is Mac OS, transferring the absolute mouse coordinate data via the absolute mouse endpoint of the first USB composite device, if the selected computer port uses the USB interface for transferring mouse data and the operating system is other than Mac OS, transferring the relative mouse coordinate data via the relative mouse endpoint of the second USB composite device, and if the selected computer port uses the PS/2 interface for transferring mouse data, translating the relative mouse coordinate data to PS/2 mouse data, then transferring the PS/2 mouse data via the emulated PS/2 mouse.

20. The method of claim 16, further comprising:
(h) if the operating system of the computer connected to the selected computer port is Mac OS, simulating a mouse left button single click or double click and transferring the simulated data to the selected computer port.

21. The method of claim 16, further comprising:
(i) storing minimum and maximum X and Y coordinate values for the touch screen which have been obtained by a first calibration process,
wherein step (d) includes converting the touch screen coordinate data to the absolute mouse coordinate data using the minimum and maximum X and Y coordinate values.

22. The method of claim 21, wherein the first calibration process includes:
touching a plurality of points on four edges of the touch screen;
obtaining the touch screen coordinate data for the plurality of points; and
calculating minimum and maximum X and Y coordinate values from the touch screen coordinate data for the plurality of points.

23. The method of claim 16, further comprising:
U) for each of the plurality of computers connected to the computer ports, storing a calibrated touch screen transfer rate, the calibrated touch screen transfer rate having been obtained by a second calibration procedure at a first display resolution of the respective computer.

24. The method of claim 16, wherein the second calibration process includes:
moving a mouse cursor to a first point on the touch screen using an external mouse of the user console;
touching the first point;
moving the mouse cursor to a second point on the touch screen using the external mouse;
touching the second point;
obtaining the touch screen coordinate data for the touched first and second points;
obtaining cumulative mouse movement increment values when the mouse cursor moves from the first point to the second point; and
calculating the calibrated touch screen transfer rate using the touch screen coordinate data for the touched first and second points and the cumulative mouse movement increment values.

25. The method of claim 23, further including:
(k) calculating a current touch screen transfer rate for a second display resolution currently set for the computer connected to the selected computer port using the calibrated touch screen transfer rate,
wherein step (d) includes calculating the relative mouse coordinate data using the absolute mouse coordinate data and the current touch screen transfer rate.

26. The method of claim 25, wherein step (k) includes re-calculating a current touch screen transfer rate when a change occurs in the display resolution of the computer connected to the selected computer port.

27. The method of claim 16, further comprising:
(1) storing a last mouse cursor position for each of the plurality of computers connected to the computer ports,
wherein step (d) includes calculating the relative mouse coordinate data using the last mouse cursor position for the computer connected to the selected computer port.

28. The method of claim 27, wherein the last mouse cursor position is generated by either an external mouse of the user console or the touch screen.

29. The method of claim 16, further comprising:
(m) displaying an OSD (on-screen display) on the touch screen; and
(n) if a touch on the touch screen is within an OSD area, converting the touch screen coordinate data to OSD mouse absolute coordinates.

30. A computer program product comprising a computer usable medium having a computer readable program code embedded therein for controlling a data processing apparatus, the data processing apparatus including a touch screen adapted for connecting to a computer, the computer readable program code configured to cause the data processing apparatus to execute a process comprising:
(a) determining a type of operating system of the computer;
(c) receiving touch screen coordinate data from the touch screen;
(d) converting the touch screen coordinate data to absolute mouse coordinate data or relative mouse coordinate data or both; and
(e) outputting either the absolute mouse coordinate data or the relative mouse coordinate data to the computer depending on the type of operating system of the computer.
